(19) United States
(12) Patent Application Publication
(10) Pub. No.: US 2015/0233401 A1
(43) Pub. Date: Aug. 20, 2015

(54) COUPLING DEVICE FOR RELEASABLE COUPLING OF OBJECTS

(71) Applicant: Hibe Holding B.V., Den Haag (NL)

(72) Inventors: Peter Berlang, Eerbeek (NL); Rajeshkoemar Hira, Den Haag (NL)

(21) Appl. No.: 14/424,911

(22) PCT Filed: Aug. 26, 2013
(86) PCT No.: PCT/NL2013/050614

§ 371 Date: Feb. 27, 2015

(30) Foreign Application Priority Data
Aug. 29, 2012 (NL) 2009380

(51) Int. Cl. F16B 1/00; E05C 19/02

(52) U.S. Cl. CPC F16B 1/0057; E05C 19/02

(57) ABSTRACT

Coupling device for releasable coupling of a first object to a second object, provided with uncoupling means for autonomous release under a predetermined condition of a first object coupled to a second object by the coupling device, which coupling device comprises a pair of connectable coupling parts, at least one coupling part of which is provided with a connection for a vacuum conduit, which coupling parts enclose a vacuum-tight space when coupled. The at least one coupling part is for instance coupled to the vacuum conduit, the uncoupling means comprise for instance a pressure conduit of a material which is not pressure-resistant above a predetermined temperature for the purpose of maintaining an overpressure in this pressure conduit below this temperature.

The invention relates to a coupling device for releasable coupling of a first object to a second object, provided with uncoupling means for autonomous release under a predetermined condition of a first object coupled to a second object by the coupling device.

An example of such a coupling device is a magnetic catch, a relatively weak electromagnet which is frequently applied in public buildings to hold in opened position a door provided with a door spring. The magnetic catch is mounted on a wall adjacently of the door and provides a magnetic force greater than the force provided by the door spring. Release of the door requires active human intervention, in this case pulling the door loose from the magnetic catch.

The power supply of the magnetic catch is coupled to a fire alarm system which automatically switches off the power supply when a fire is detected, as a result of which the door is closed by the door spring in order to prevent undesired spreading of smoke and rapid spread of a possible fire.

There are situations where, when a fire is detected, there is a need to open instead of close doors of escape routes for people in buildings, or to open gates, doors or partitions in animal accommodation, for instance for poultry, untethered cows or pigs, or to release individually tethered animals.

In such situations the known magnetic catch is unsuitable for use because it produces insufficient force to hold a door in an animal accommodation closed counter to the force which can be exerted on this door by an animal. An electromagnet is moreover susceptible to power failure, which can result in undesired opening of a closed door.

It is an object of the invention to provide a releasable coupling device for releasable coupling of a first object to a second object, using which a strong coupling of the objects can be realized.

It is a further object to provide a coupling device using which a coupling between two objects can be maintained autonomously, i.e. without the continuous availability of a power source or electricity supply.

Such a coupling device has to release coupled objects autonomously, i.e. without human or electromagnetic intervention, subject to the occurrence of a predetermined situation, for instance a fire breaking out or a lightning strike.

This coupling device also has to be low-maintenance and relatively inexpensive to purchase and operate.

It must further be possible to integrate the coupling device in simple manner into an existing infrastructure of for instance a building adapted for the presence of a large number of people or animals, such as a care home, discotheque or free stall barn.

These objects are achieved, and other advantages gained, with a coupling device of the type specified in the preamble which comprises according to the invention a pair of connectable coupling parts, at least one coupling part of which is provided with a connection for a vacuum conduit, which coupling parts enclose a vacuum-tight space when coupled.

An example of such a pair of connectable coupling parts is a pair of co-acting Magdeburg hemispheres, one of which is provided with a vacuum connection. With this vacuum connection the spherical vacuum space is connected to the vacuum conduit, which is configured such that the vacuum therein is discontinued autonomously as a result of the predetermined condition occurring.

In an embodiment of the coupling device according to the invention at least one of the coupling parts comprises a hemisphere provided with a peripheral edge, wherein the peripheral edge is configured to provide a vacuum-tight seal between the coupling parts when in contact with a corresponding part of the other coupling part. In this embodiment the second coupling part is for instance a thick, flat, round disc of a sufficiently stiff material which forms the flat underside of a hemispherical vacuum space. The advantage of a flat, round disc is that it can be anchored in simple manner, for instance on a door.

In a subsequent embodiment at least one of the coupling parts in the coupling device according to the invention comprises an elongate space open on one side and provided with a peripheral edge, wherein the peripheral edge is configured to provide a vacuum-tight seal between the coupling parts when in contact with a corresponding part of the other coupling part. The second coupling part here is for instance a thick, flat, elongate plate of a sufficiently stiff material which forms the flat underside of a hemispherical vacuum space. The advantage of a flat, elongate plate is that it can be anchored in simple manner at a relatively narrow location, for instance to a bar of a fence.

In a particularly advantageous embodiment the predetermined condition comprises of exceeding a predetermined temperature at a predetermined location.

A coupling device according to this embodiment is particularly suitable for closing a fire safety emergency exit for a building intended to provide space to a large number of people or animals, such as a care home, discotheque or free stall barn.

A coupling device according to the invention preferably comprises a vacuum conduit and a pressure conduit, wherein the at least one coupling part is coupled to the vacuum conduit, the uncoupling means comprise a pressure conduit which runs along the determined location and is manufactured from a material which is not pressure-resistant above the predetermined temperature for the purpose of maintaining an overpressure in this pressure conduit below this temperature, and the vacuum conduit and the pressure conduit are connectable to each other by means of a valve in a manner such that, in a situation where there is overpressure in the pressure conduit, the vacuum conduit and the pressure conduit are separated, and in a situation without overpressure in the pressure conduit the vacuum conduit and the pressure conduit are coupled to each other.

In this preferred embodiment the pressure conduit and the vacuum conduit form separate circuits. The feature that the overpressure in the pressure conduit cannot be maintained above the predetermined temperature, for instance because the pressure conduit then melts or burns through, makes the pressure conduit suitable as fire sensor. The loss of the overpressure in the pressure conduit results in ambient pressure occurring in the pressure conduit and in a coupling to the vacuum conduit, whereby the ambient pressure likewise results in the vacuum conduit, as a result of which the coupling elements of the coupling device connected to the vacuum conduit are released.

In this embodiment the pressure conduit is for instance manufactured from a flexible material and is for instance provided with a reinforcement. This reinforcement is for instance of stainless steel wire mesh.

A flexible material provides the practical advantage of a simple and rapid fitting of the pressure conduit, and the reinforcement contributes toward the strength of this conduit, which in conditions other than fire or lightning strike has to be able to withstand mechanical forces and be sufficiently robust.

In this embodiment the valve is for instance a pressure-controlled 4/2-way valve, preferably comprising a valve block confined under a spring pressure and a pressure chamber connected to the pressure conduit, wherein in the situation where there is overpressure in the pressure conduit the pressure in the pressure chamber is greater than the spring pressure.

The pressure-controlled 4/2-way valve is preferably an electropneumatic valve.

Provided in an embodiment of a coupling device comprising a vacuum conduit is a vacuum pump for applying and maintaining the vacuum in the vacuum conduit.

This coupling device is provided in an embodiment with measuring and control means configured to measure and control the vacuum in the vacuum conduit.

In order to prevent a vacuum pump continuing to operate following rapid loss of the vacuum, resulting in release of the coupling, in yet another embodiment the measuring and control means are configured to switch off the vacuum pump in the case the vacuum in the vacuum conduit is lost within a predetermined period of time.

Provided in an embodiment of a coupling device comprising a pressure conduit is a compressor for applying and maintaining the overpressure in the pressure conduit.

This coupling device is provided in an embodiment with measuring and control means configured to measure and control the overpressure in the pressure conduit.

In order to prevent a compressor continuing to operate following rapid loss of the overpressure, for instance in the case of fire or lightning strike, resulting in loss of the vacuum in the vacuum conduit and release of the coupling, in another embodiment the measuring and control means are configured to switch off the compressor in the case the overpressure in the pressure conduit is lost within a predetermined period of time.

The coupling device according to the invention is suitable for securing a single animal in a manner safe from fire, which animal is autonomously released after outbreak of fire at the location where the animal is present. The animal is here the first object, and the second object forms part of the fixed world, for instance a wall or pillar in an animal accommodation.

The coupling device according to the invention is particularly suitable for keeping closed in fire-protected manner a door which is autonomously unlocked following the outbreak of fire at one or more predetermined locations. A pivotable closure of a surface enclosed by a wall is here the first object, and the second object forms part of this wall.

The invention also relates to an assembly of coupling devices comprising a first coupling device and at least one second coupling device with a vacuum conduit and a pressure conduit, wherein the respective vacuum conduits and pressure conduits of the first and of the second coupling device form respectively a shared vacuum conduit and pressure conduit.

The invention also relates to a coupling device for releasable coupling of a first object to a second object, comprising a pair of connectable coupling parts, of which at least one coupling part is provided with a connection for a vacuum conduit, which coupling parts enclose a vacuum-tight space when coupled, wherein at least one of the coupling parts bounds a non-spherical space open on one side and provided with a peripheral edge, wherein the peripheral edge is configured to provide a vacuum-tight seal between the coupling parts when in contact with a corresponding part of the other coupling part.

This coupling device is particularly suitable for coupling objects, wherein these objects are not required to be autonomously releasable.

The invention will be elucidated hereinbelow on the basis of exemplary embodiments with reference to the drawings.

In the drawings

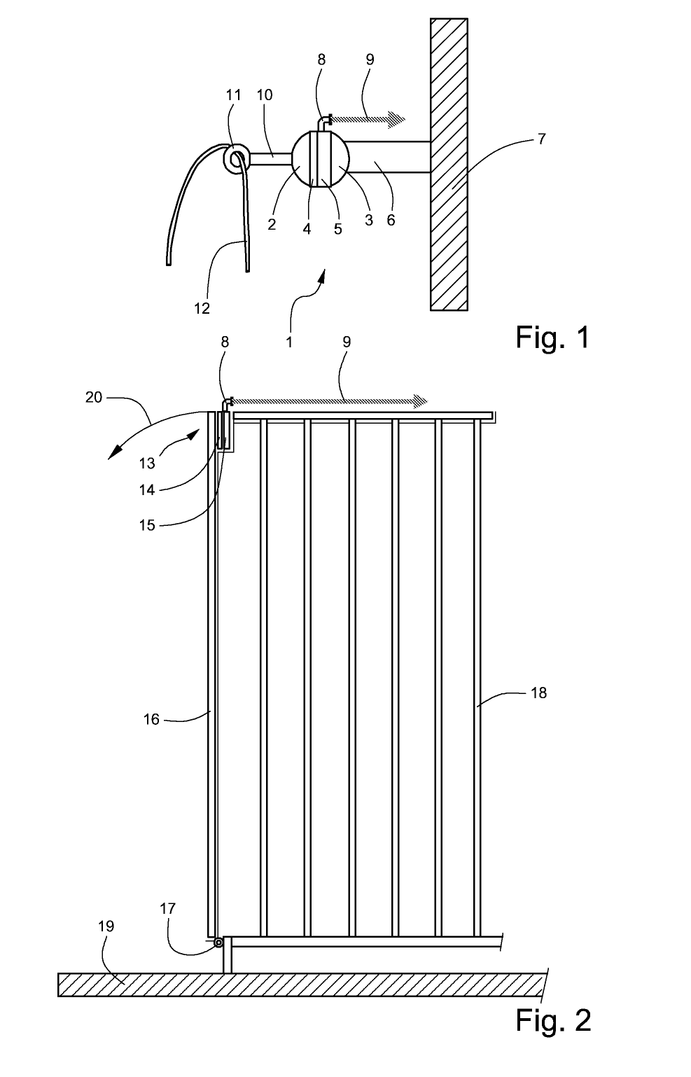

FIG. 1 is a schematic view of a first embodiment of a coupling device according to the invention,

FIG. 2 is a schematic view of a second embodiment of a coupling device according to the invention,

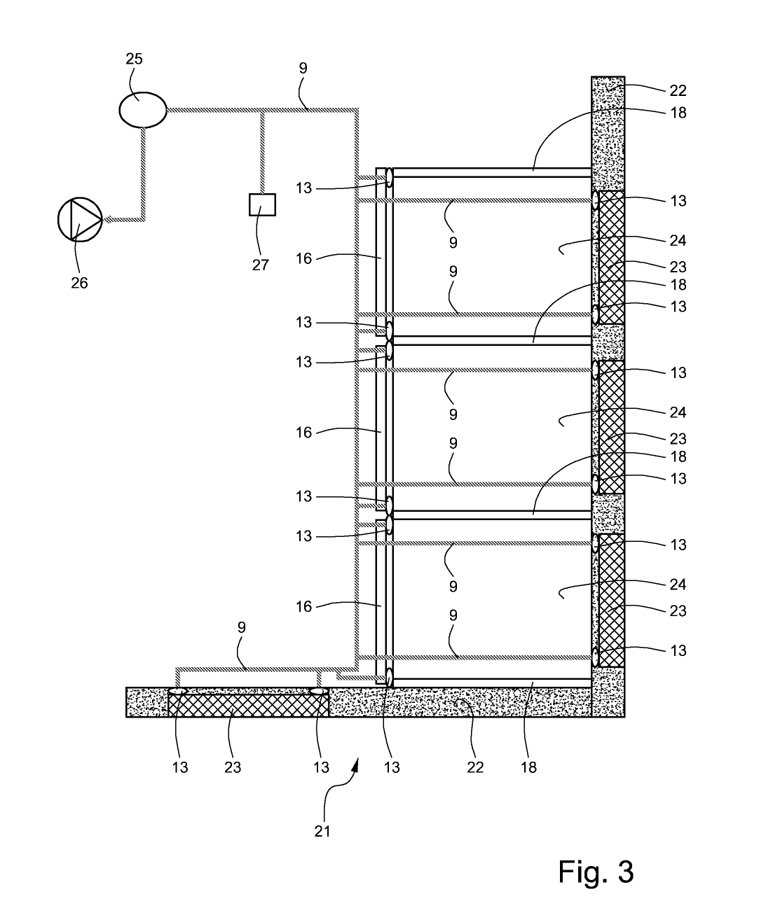

FIG. 3 is a schematic view of a building provided with a vacuum conduit for a coupling device as shown in FIG. 1 or FIG. 2,

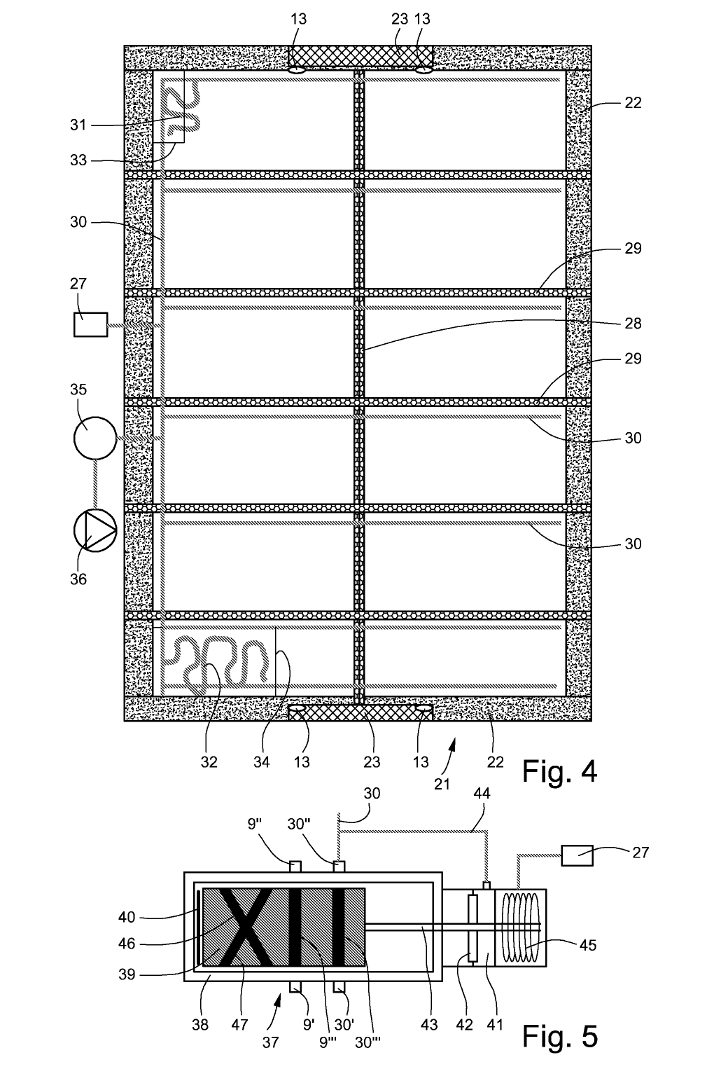

FIG. 4 is a schematic view of a building provided with a pressure conduit for a coupling device as shown in FIG. 1 or FIG. 2,

FIG. 5 is a schematic view of a 4/2-way valve for a coupling device as shown in FIG. 1 or FIG. 2, and

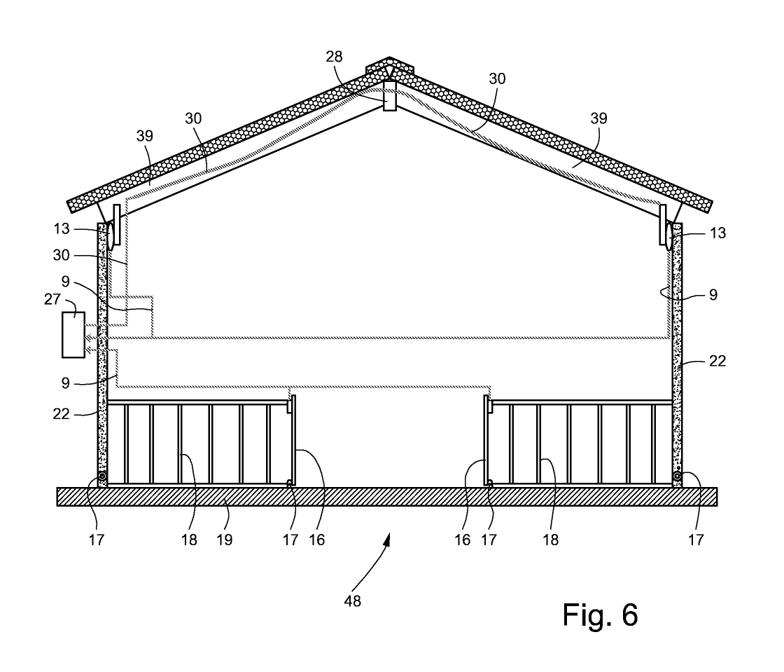

FIG. 6 is a schematic view of a building provided with an assembly of coupling devices according to the invention.

Corresponding components are designated in the figures with the same reference numerals.

FIG. 1 shows a coupling device 1 assembled from two hemispheres 2, 3 with corresponding peripheral edges 4, 5 which in contact with each other form a vacuum-tight seal. The first hemisphere 2 is provided with a rod 10 and a ring 11, through which a rope 12 is placed for the purpose of securing for instance an animal (not shown). The second hemisphere 3 is connected with a rod 6 to a wall 7, for instance a stall wall, and is provided with a vacuum connection 8 for connecting the space enclosed by hemispheres 2, 3 to a vacuum conduit (represented by arrow 9).

FIG. 2 shows a coupling device 13 assembled from a flat steel plate 14 and an elongate, half-open chamber 15 provided with a peripheral edge which in contact with steel plate 14 forms a vacuum-tight seal. Steel plate 14 is attached to a panel 16 which is mounted on its underside via hinges 17 on a fence 18 on a floor 19, for instance of a roaming area in an animal accommodation. A vacuum space is enclosed by flat plate 14 and half-open chamber 15. The half-open chamber 15 is provided with a vacuum connection for connecting the vacuum space to a vacuum conduit (represented by arrow 9).

When a vacuum is maintained in the space enclosed by the half-open chamber 15 and steel plate 14 the panel 16 is coupled to fence 18, and when the vacuum is discontinued it will be possible for panel 16 to pivot downward about its hinges 17 (represented by circular arc 20).

FIG. 3 shows a top view of a part of a building, for instance an animal accommodation 21, with an outside wall 22 in which escape doors 23 are arranged, and roaming areas 24 for livestock which are enclosed by fences 18 and panels 16 as shown in FIG. 2. Panels 16 and escape doors 23 are locked to the respective fences 18 and outside wall 22 using respective coupling devices 13, all of which are connected to a shared vacuum conduit 9. Vacuum conduit 9 is connected to a vacuum tank 25, a vacuum pump 26 and a measuring and control unit 27. Vacuum pump 26 is operated by the measuring and control unit 27, which is for instance programmed such that pump 26 is started in the case of a slow deterioration of the measured vacuum to a predetermined limit value and switched off when a determined value for the vacuum is reached, while pump 26 is switched off in the case of a sudden loss of the vacuum in vacuum conduit 9 within a predetermined period of time.

FIG. 4 is a schematic top view of the upper floor of the animal accommodation 21 shown in FIG. 3, with outside wall 22, escape doors 23, ridge purlin 28 and roof trusses 29. Guided under the roof and along trusses 29 is a pressure conduit 30 of a reinforced, flexible and flammable material which has branches 31, 32 to for instance a distribution cabinet 33 or a hay storage 34. Pressure conduit 30 is connected to a pressure tank 35, a compressor 36 and the measuring and control unit 27. Compressor 36 is operated by the measuring and control unit 27, which is for instance programmed such that compressor 36 is started in the case of a slow decrease in the measured overpressure to a predetermined limit value and switched off when a desired value for the overpressure is reached, while compressor 36 is switched off in the case of a sudden loss of the overpressure in pressure conduit 30 within a predetermined period of time.

FIG. 5 shows an electropneumatic 4/2-way valve 37 with chamber 38 in which a valve block 39 is received for displacement counter to the pressure of a compression spring 40. Chamber 38 is provided with inlets 9′, 30′ and outlets 9″, 30″ which are connected in series to the respective vacuum conduit 9 and pressure conduit 30 shown in FIG. 3. Valve block 38 is provided with channels 9′″ and 30′″ which in actuated state (as shown in the figure) maintain a direct connection respectively between inlet 9′ and outlet 9″ and between inlet 30′ and outlet 30″. Valve 37 is provided with a pressure chamber 41 in which a piston rod 43 coupled to valve block 38 and to a piston 42 is displaceably received. Pressure chamber 41 is connected by means of a conduit 44 to pressure conduit 30 in a manner such that, in the situation where there is overpressure in pressure conduit 30, the pressure in pressure chamber 41 is greater than the spring pressure of spring 40. Provided for the purpose of setting valve block 38 into the actuated state is a relay 45 which is controlled by the measuring and control unit 27 and switched off as soon as an overpressure is determined in pressure conduit 30. If the overpressure in pressure conduit 30 is lost, the overpressure in pressure chamber 41 is also lost, as a result of which valve block 39 is displaced in chamber 38 and two cross connections 46, 47 couple respectively inlet 9′ to outlet 30″ and inlet 30′ to outlet 9″ of valve chamber 38, as a result of which vacuum conduit 9 is placed into open connection with pressure conduit 30, wherein the two conduits 9, 30 are at ambient pressure and the coupling devices 1, 13 connected to vacuum conduit 9 are uncoupled.

FIG. 6 is a schematic side view of a part of a building, for instance an animal accommodation 48, with outside walls 22 and roaming areas with fences 18 and panels 16, as shown in FIG. 2. Outside walls 22 are tiltable about hinges 17 on the underside, and are locked to roof trusses 39 on their upper side by coupling devices 13. Further shown are pressure conduits 30 of a flexible, reinforced plastic material which are guided along flammable locations, for instance along roof trusses 39, and vacuum conduits 9 running to the different coupling devices 13.

It is noted that the coupling device described here can be applied in numerous situations, also in existing buildings, in particular livestock accommodation, where vacuum pumps and compressors often form part of the provisions available, which can result in a considerable reduction in the cost of installing and connecting the coupling devices.

For the sake of simplicity all mutually connected coupling devices are connected to one vacuum conduit in the above described exemplary embodiments. In practical situations it is of course possible to branch the vacuum conduits, wherein each branch can be monitored and controlled independently of the others by a central measuring and control unit.

It is also possible to switch off a measuring and control unit and to switch to manual operation, for instance in order to discontinue the vacuum in the vacuum conduits in a livestock accommodation in situations in which a fire has not broken out but it is nevertheless desirable to unlock doors quickly, for instance when smoke from a fire elsewhere penetrates the building.

1. Coupling device (1; 13) for releasable coupling of a first object (11; 16) to a second object (7; 18), provided with uncoupling means for autonomous release under a predetermined condition of a first object (11; 16) coupled to a second object (7; 18) by the coupling device (1; 13), characterized in that the coupling device comprises a pair of connectable coupling parts (2, 3; 14, 15), at least one coupling part (3; 15) of which is provided with a connection (8) for a vacuum conduit (9), which coupling parts (2, 3; 14, 15) enclose a vacuum-tight space when coupled.

2. Coupling device (1) as claimed in claim 1, characterized in that at least one of the coupling parts comprises a hemisphere (2, 3) provided with a peripheral edge (4, 5), wherein the peripheral edge (4, 5) is configured to provide a vacuum-tight seal between the coupling parts (2, 3) when in contact with a corresponding part (5, 4) of the other coupling part (3, 2).

3. Coupling device (13) as claimed in claim 1, characterized in that at least one of the coupling parts (15) bounds a space (15) open on one side and provided with a peripheral edge, wherein the peripheral edge is configured to provide a vacuum-tight seal between the coupling parts (14, 15) when in contact with a corresponding part of the other coupling part (14).

4. Coupling device (1; 13) as claimed in any of the claims 1-3, characterized in that the predetermined condition comprises of exceeding a predetermined temperature at a predetermined location.

5. Coupling device (1; 13) as claimed in any of the claims 1-4, characterized in that it comprises a vacuum conduit (9) and a pressure conduit (30), wherein
the at least one coupling part (3; 15) is coupled to the vacuum conduit (9),
the uncoupling means comprise a pressure conduit (30) which runs along the determined location and which is of a material which is not pressure-resistant above the predetermined temperature for the purpose of maintaining an overpressure in this pressure conduit (30) below this temperature, and
the vacuum conduit (9) and the pressure conduit (30) are connectable to each other by means of a valve (37) in a manner such that, in a situation where there is overpressure in the pressure conduit (30), the vacuum conduit (9) and the pressure conduit (30) are separated, and in a situation without overpressure in the pressure conduit (30) the vacuum conduit (9) and the pressure conduit (30) are coupled to each other.

6. Coupling device (1; 13) as claimed in claim 5, characterized in that the pressure conduit (30) is manufactured from a flexible material.

7. Coupling device (1; 13) as claimed in any of the claims 5-6, characterized in that the pressure conduit (30) is provided with a reinforcement.

8. Coupling device (1; 13) as claimed in any of the claims 5-7, characterized in that the valve is a pressure-controlled 4/2-way valve (37).

9. Coupling device (1; 13) as claimed in claim 8, characterized in that the pressure-controlled 4/2-way valve (37) comprises a valve block (39) confined under a spring pressure and a pressure chamber (41) connected to the pressure conduit (30), wherein in the situation where there is overpressure in the pressure conduit (30) the pressure in the pressure chamber (41) is greater than the spring pressure.

10. Coupling device (1; 13) as claimed in claim 9, characterized in that the pressure-controlled 4/2-way valve is an electropneumatic valve (37).

11. Coupling device (1; 13) as claimed in any of the claims 5-9, characterized in that a vacuum pump (26) is provided for applying and maintaining the vacuum in the vacuum conduit (9).

12. Coupling device (1; 13) as claimed in claim 11, characterized in that it is provided with measuring and control means (27) configured to measure and control the vacuum in the vacuum conduit (9).

13. Coupling device (1; 13) as claimed in claims 11 and 12, characterized in that the measuring and control means (27) are configured to switch off the vacuum pump (26) in the case the vacuum in the vacuum conduit (9) is lost within a predetermined period of time.

14. Coupling device (1; 13) as claimed in any of the claims 5-13, characterized in that a compressor (36) is provided for applying and maintaining the overpressure in the pressure conduit (30).

15. Coupling device (1; 13) as claimed in claim 14, characterized in that it is provided with measuring and control means (27) configured to measure and control the overpressure in the pressure conduit (30).

16. Coupling device (1; 13) as claimed in claims 14 and 15, characterized in that the measuring and control means (27) are configured to switch off the compressor (36) in the case the overpressure in the pressure conduit (30) is lost within a predetermined period of time.

17. Coupling device (1; 13) as claimed in any of the claims 1-16, wherein the first object is an animal and the second object (7) forms part of the fixed world.

18. Coupling device (1; 13) as claimed in any of the claims 1-16, wherein the first object is a pivotable closure (16) of a surface (19) enclosed by a wall (18) and the second object forms part of this wall (18).

19. Assembly of coupling devices comprising a first coupling device (1; 13) and at least one second coupling device (1; 13) as claimed in any of the claims 5-18, wherein the respective vacuum conduits and pressure conduits of the first and of the second coupling device form respectively a shared vacuum conduit (9) and pressure conduit (30).

20. Coupling device (13) for releasable coupling of a first object (16) to a second object (18), comprising a pair of connectable coupling parts (14, 15), of which at least one coupling part (15) is provided with a connection (8) for a vacuum conduit (9), which coupling parts (14, 15) enclose a vacuum-tight space when coupled, characterized in that at least one of the coupling parts (15) bounds a non-spherical space open on one side and provided with a peripheral edge, wherein the peripheral edge is configured to provide a vacuum-tight seal between the coupling parts (14, 15) when in contact with a corresponding part of the other coupling part (14).
